(19) United States
(12) Patent Application Publication
(10) Pub. No.: US 2023/0306109 A1
(43) Pub. Date: Sep. 28, 2023

(54) STRUCTURED STORAGE OF ACCESS DATA

(71) Applicant: Microsoft Technology Licensing, LLC, Redmond, WA (US)

(72) Inventors: Sagi LOWENHARDT, Ramat Gan (IL); Shimon EZRA, Petach Tikva (IL); Shalini Ramakrishna AKELLA, Sammamish, WA (US)

(21) Appl. No.: 17/702,004

(22) Filed: Mar. 23, 2022

(51) Int. Cl. G06F 21/55; G06F 16/11

(52) U.S. Cl. CPC G06F 21/552; G06F 16/125; G06F 2221/2101; G06F 2221/2141

(57) ABSTRACT

Some embodiments manage storage of access data to provide flexible and granular control over storage costs without risking policy compliance, regulatory compliance, or data breach investigation. Resources are classified and given metadata labels. Resource access data is associated with the accessed resource metadata label. A mapping is defined between metadata groups and access data storage boxes. Access data storage box definitions may specify metadata labels. A mapping structure also defines a policy governing use of available storage capacity in access data storage boxes. Per the policy and the available capacity, particular access data may be stored in a particular box, be spilled over to a different box, or be denied storage. Accordingly, the costs of storing access data can be capped and made predictable, and storage of specific kinds of access data can be favored.

### BACKGROUND

Noon Computing systems often make economic, educational, scientific, and other advances feasible. But many computing systems are complex, and so they sometimes operate in unexpected ways. In order to help improve understanding of a computing system's operations, various kinds of logs may be maintained. Logged data may represent events or operational status values that occur while a computing system executes. Logs may provide helpful data when administrators, developers, or other professionals seek ways to improve a computing system's availability, effectiveness, efficiency, security, or usability, for example.

Advances are still possible in computing system logging technology. Advances may provide or enhance previously available benefits of various approaches to logging.

### SUMMARY

Some embodiments described herein address technical challenges related to logging a particular category of data, namely, access data. Access data does not typically stand on its own. Rather, it derives value from its relationship to stored data or to other resources in a computing system. Access data represents attempts to access stored data or other resources. Access data is generated by monitoring access attempts. The access-monitored resources may include, e.g., computing hardware, computer-controlled hardware, network bandwidth, or various electronic communication points. Both the stored data and the access data may be subject to storage requirements that specify which particular data is kept and for how long, e.g., policy, privacy, regulatory, or security requirements.

Unlike much of the stored data, however, the access data potentially grows in size rapidly and without any upper limit. As a technical matter, and as a financial one, unbounded storage of access data is not feasible. Recognizing this fact raises technical challenges, such as how to limit access data storage without disregarding regulatory or other storage requirements, and how to efficiently and effectively factor in data storage costs during access data storage management.

Some embodiments manage storage of access data using particular storage management data structures, also referred to as “storage structures”. A metadata groups structure defines at least two metadata groups, with each metadata group including at least one metadata label. An access data boxes structure defines at least two access data boxes, with each access data box including digital storage. A mapping structure represents a mapping between the metadata groups structure and the access data boxes structure. The mapping structure includes an available capacity usage policy, also referred to as a “capacity usage policy”. The capacity usage policy may embody policy, privacy, regulatory, security, or other access data storage requirements, and may reflect data storage costs.

In operation, an embodiment identifies access data which represents one or more attempts to access stored data. The stored data is associated with at least one metadata label. The embodiment selects a particular metadata group based on at least the metadata label, chooses a particular access data box based on at least the mapping and the particular metadata group, and ascertains an available capacity of the particular access data box. Then the embodiment allows or denies placement of access data in the particular access data box, based on the available capacity and the capacity usage policy.

Other technical activities and characteristics pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims as properly understood, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating aspects of computer systems and also illustrating configured storage media;

FIG. 2 is a block diagram illustrating aspects of a computing system which has one or more of the access data structured storage enhancements taught herein;

FIG. 3 is a block diagram illustrating an enhanced system configured with access data structured storage functionality;

FIG. 4 is a structural diagram illustrating aspects of some access data storage management structures and their context;

FIG. 5 is an instance of the FIG. 4 diagram illustrating particular metadata labels, a particular metadata group structure, and particular access data box definitions;

FIG. 6 is a block diagram further illustrating aspects of some access data storage management structures;

FIG. 7 is a block diagram illustrating examples of some access data sources;

FIG. 8 is a block diagram illustrating some examples of data characterizations;

FIG. 9 is a block diagram illustrating some additional aspects of some access data storage management systems;

FIG. 10 is a flowchart illustrating steps in some access data structured storage methods;

FIG. 11 is a flowchart further illustrating steps in some access data structured storage methods, incorporating FIG. 10; and

FIG. 12 is a flow diagram illustrating resource access and access data storage management for a particular mapping structure embodied in an access data storage manager.

### DETAILED DESCRIPTION

### Overview

Innovations may expand beyond their origins, but understanding an innovation's origins can help one more fully appreciate the innovation. In the present case, some teachings described herein were motivated by technical challenges arising from ongoing efforts to help Microsoft customers investigate data breaches.

In particular, Microsoft innovators explored ways to help customers manage their logs. The innovators recognized that a data breach investigation could involve digging into access data that is stored in various logs. Access data often helps cybersecurity investigators as they try to answer breach-related questions such as who accessed which particular data, when the access occurred, what kind of access occurred (e.g., was it previously known or not, was it public or private), the kind of data accessed (e.g., sensitivity level), and what may have been done with (or done to) the accessed data.

The innovators also recognized several factors that tend to make the amount of access data potentially very large, e.g., many gigabytes, or even more than a terabyte in size, for a given breach investigation. One factor is that access data can be very helpful to answer breach-related questions, so there is a reasonable viewpoint that having more access data is better than having less. Another factor is that attacker activities that laid a foundation for a breach may have happened weeks or even months before the breach was detected, so even months-old access data can be very helpful. In addition, company policies and regulatory requirements may lead a company to keep a copy of access data for weeks, months, or even years after the occurrence of any access attempt that is described in the access data.

Unfortunately, storing access data can be expensive. As with other kinds of data, the cost of storing access data often depends on the amount of storage consumed. As the amount of access data stored increases, so does the access data storage cost. Accordingly, the innovators also explored ways to help customers reduce the cost of storing access data.

In short, factors that increase the amount of access data, together with the storage cost of access data, pose a challenge: how to reduce the cost of storing access data, without increasing breach investigation difficulty and without violating company policies or regulatory requirements. This problem may be refined into the related technical challenge of how to reduce the amount of stored access data over time, while maintaining control over which access data is stored and for how long, thereby providing access data storage management which is sufficient to avoid any unacceptable increase in breach investigation difficulty, avoid any unacceptable violation of company policy, and avoid any violation of regulatory requirements.

One response to these challenges is to scan data and classify it according to its sensitivity. Unauthorized access to sensitive data is likely to cause more harm than unauthorized access to non-sensitive data. Accordingly, the amount of access data that is kept can potentially be reduced by filtering access data based on the sensitivity of the corresponding accessed data (“accessed” herein means actually accessed or potentially accessed or both).

For example, a company may keep a copy of access data that describes attempts to access sensitive data, but discard access data that describes attempts to access non-sensitive data. A keep-or-discard filter may be more nuanced, e.g., both kinds of access data may be kept for some period, such as three months. After that time, the access data that describes attempts to access sensitive data is kept for another three months, but the access data that describes attempts to access non-sensitive data is discarded, e.g., overwritten.

Embodiments described herein address these challenges by utilizing various access data structured storage functionalities which have specific data structures for access data storage management. In some embodiments, metadata labels such as “sensitive” or “non-sensitive” are associated with accessed data. In addition, storage space for access data is divided into access data boxes which have respective storage budgets. A capacity usage policy specifies a relationship between the access data and the access data storage boxes, based at least in part on the kind of access data. Different kinds of access data are specified, where the kind of access data depends on the metadata label associated with the corresponding accessed data.

Accordingly, the access data structured storage functionality provides granular control over access data storage amounts, and hence over access data storage costs, for respective kinds of access data. In addition to being granular as to the kind of access data, the control provided is also flexible. For example, different embodiments may use different metadata labels or different numbers of metadata labels or both, may have differently sized access data storage boxes, may handle access data storage box overflow situations differently, and may keep different kinds of access data for different periods of time.

This granular and flexible access data storage management allows an entity to control their storage costs while avoiding any unacceptable increase in breach investigation difficulty, avoiding any unacceptable violation of company policy, and avoiding any violation of regulatory requirements. This assumes the entity has a sufficient budget to obtain at least minimal storage; a storage budget less than the minimum needed to satisfy regulatory requirements would still lead to a violation of those regulatory requirements. However, the storage of access data which is not essential to meet regulatory requirements can be reduced or avoided using an embodiment.

Operating Environments

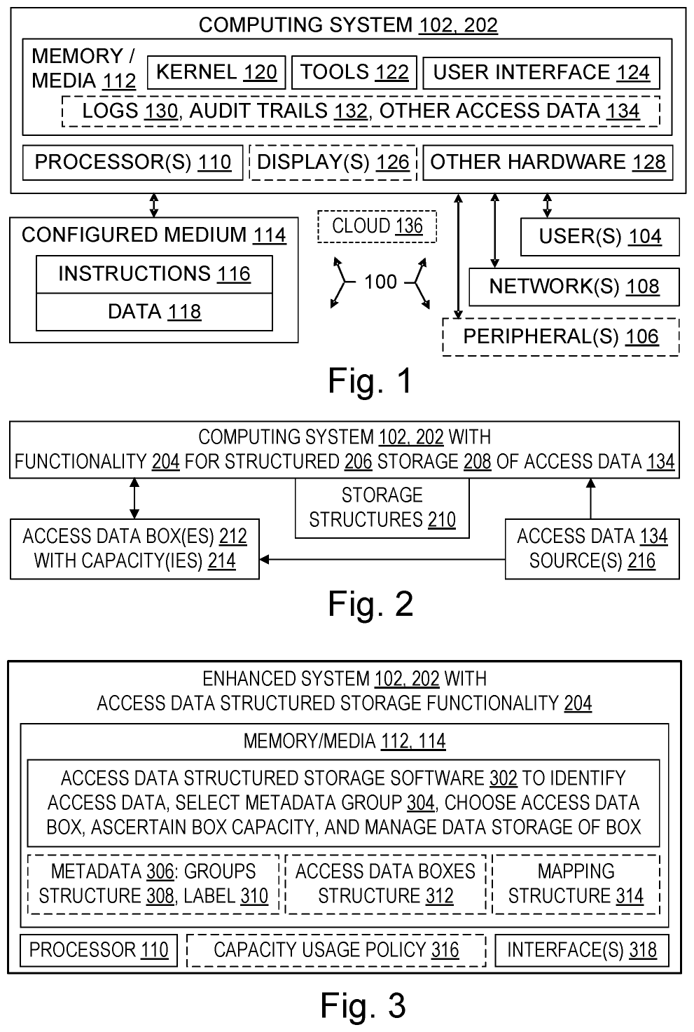

With reference to FIG. 1, an operating environment 100 for an embodiment includes at least one computer system 102. The computer system 102 may be a multiprocessor computer system, or not. An operating environment may include one or more machines in a given computer system, which may be clustered, client-server networked, and/or peer-to-peer networked within a cloud 136. An individual machine is a computer system, and a network or other group of cooperating machines is also a computer system. A given computer system 102 may be configured for end-users, e.g., with applications, for administrators, as a server, as a distributed processing node, and/or in other ways.

Human users 104 may interact with a computer system 102 user interface 124 by using displays 126, keyboards 106, and other peripherals 106, via typed text, touch, voice, movement, computer vision, gestures, and/or other forms of I/O. Virtual reality or augmented reality or both functionalities may be provided by a system 102. A screen 126 may be a removable peripheral 106 or may be an integral part of the system 102. The user interface 124 may support interaction between an embodiment and one or more human users. The user interface 124 may include a command line interface, a graphical user interface (GUI), natural user interface (NUI), voice command interface, and/or other user interface (UI) presentations, which may be presented as distinct options or may be integrated.

System administrators, network administrators, cloud administrators, security analysts and other security personnel, operations personnel, developers, testers, engineers, auditors, and end-users are each a particular type of human user 104. Automated agents, scripts, playback software, devices, and the like running or otherwise serving on behalf of one or more humans may also have accounts, e.g., service accounts. Sometimes an account is created or otherwise provisioned as a human user account but in practice is used primarily or solely by one or more services; such an account is a de facto service account. Although a distinction could be made, “service account” and “machine-driven account” are used interchangeably herein with no limitation to any particular vendor.

Storage devices and/or networking devices may be considered peripheral equipment in some embodiments and part of a system 102 in other embodiments, depending on their detachability from the processor 110. Other computer systems not shown in FIG. 1 may interact in technological ways with the computer system 102 or with another system embodiment using one or more connections to a cloud 136 and/or other network 108 via network interface equipment, for example.

Each computer system 102 includes at least one processor 110. The computer system 102, like other suitable systems, also includes one or more computer-readable storage media 112, also referred to as computer-readable storage devices 112. Tools 122 may include software apps on mobile devices 102 or workstations 102 or servers 102, as well as APIs, browsers, or webpages and the corresponding software for protocols such as HTTPS, for example.

Storage media 112 may be of different physical types. The storage media 112 may be volatile memory, nonvolatile memory, fixed in place media, removable media, magnetic media, optical media, solid-state media, and/or of other types of physical durable storage media (as opposed to merely a propagated signal or mere energy). In particular, a configured storage medium 114 such as a portable (i.e., external) hard drive, CD, DVD, memory stick, or other removable nonvolatile memory medium may become functionally a technological part of the computer system when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks, and other memory storage devices which are not readily removable by users 104. For compliance with current United States patent requirements, neither a computer-readable medium nor a computer-readable storage medium nor a computer-readable memory is a signal per se or mere energy under any claim pending or granted in the United States.

The storage device 114 is configured with binary instructions 116 that are executable by a processor 110; “executable” is used in a broad sense herein to include machine code, interpretable code, bytecode, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth. Such data is also transformed by backup, restore, commits, aborts, reformatting, and/or other technical operations.

Although an embodiment may be described as being implemented as software instructions executed by one or more processors in a computing device (e.g., general purpose computer, server, or cluster), such description is not meant to exhaust all possible embodiments. One of skill will understand that the same or similar functionality can also often be implemented, in whole or in part, directly in hardware logic, to provide the same or similar technical effects. Alternatively, or in addition to software implementation, the technical functionality described herein can be performed, at least in part, by one or more hardware logic components. For example, and without excluding other implementations, an embodiment may include hardware logic components 110, 128 such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In addition to processors 110 (e.g., CPUs, ALUs, FPUs, TPUs, GPUs, and/or quantum processors), memory/storage media 112, peripherals 106, and displays 126, an operating environment may also include other hardware 128, such as batteries, buses, power supplies, wired and wireless network interface cards, for instance. The nouns “screen” and “display” are used interchangeably herein. A display 126 may include one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments, the system includes multiple computers connected by a wired and/or wireless network 108. Networking interface equipment 128 can provide access to networks 108, using network components such as a packet-switched network interface card, a wireless transceiver, or a telephone network interface, for example, which may be present in a given computer system. Virtualizations of networking interface equipment and other network components such as switches or routers or firewalls may also be present, e.g., in a software-defined network or a sandboxed or other secure cloud computing environment. In some embodiments, one or more computers are partially or fully “air gapped” by reason of being disconnected or only intermittently connected to another networked device or remote cloud. In particular, access data structured storage functionality could be installed on an air gapped network and then be updated periodically or on occasion using removable media 114. A given embodiment may also communicate technical data and/or technical instructions through direct memory access, removable or non-removable volatile or nonvolatile storage media, or other information storage-retrieval and/or transmission approaches.

One of skill will appreciate that the foregoing aspects and other aspects presented herein under “Operating Environments” may form part of a given embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but may interoperate with items in the operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current innovations.

More About Systems

FIG. 2 illustrates a computing system 102 configured by one or more of the access data structured storage enhancements taught herein, resulting in an enhanced system 202. This enhanced system 202 may include a single machine, a local network of machines, machines in a particular building, machines used by a particular entity, machines in a particular datacenter, machines in a particular cloud, or another computing environment 100 that is suitably enhanced. FIG. 2 items are discussed at various points herein, and additional details regarding them are provided in the discussion of a List of Reference Numerals later in this disclosure document.

FIG. 3 illustrates an enhanced system 202 which is configured with access data structured storage software 302 to provide access data structured storage functionality 204. Software 302 and other FIG. 3 items are discussed at various points herein, and additional details regarding them are provided in the discussion of a List of Reference Numerals later in this disclosure document.

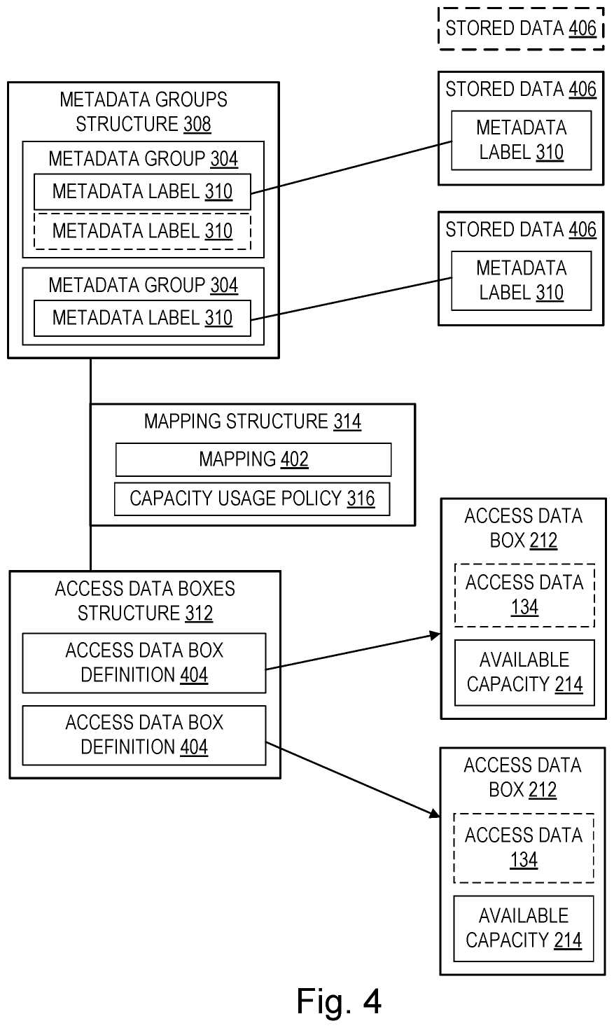

FIG. 4 shows aspects of some access data storage management structures 210 and their context. This is not a comprehensive summary of all access data storage management structures 210, or a comprehensive summary of all aspects of an environment 100 or system 102 or other context of structures 210, or a comprehensive summary of all access data storage management mechanisms for potential use in or with a system 102. FIG. 4 items are discussed at various points herein, and additional details regarding them are provided in the discussion of a List of Reference Numerals later in this disclosure document.

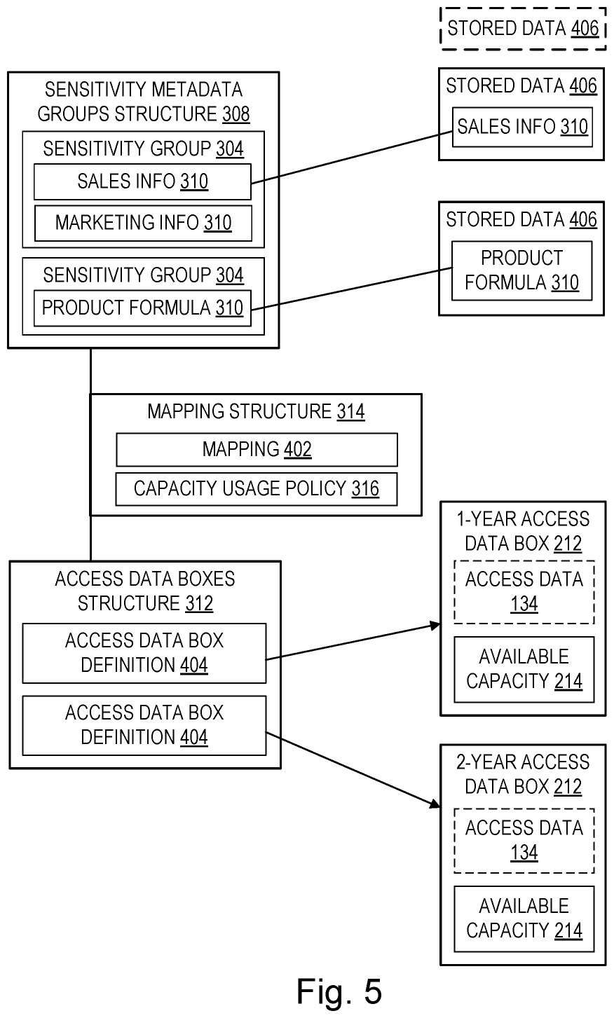

FIG. 5 is an instance of the FIG. 4 diagram illustrating particular metadata labels 310, a particular metadata group structure 308, and particular access data box definitions 404. This is not a comprehensive summary of all access data storage management structures 210, or a comprehensive summary of all aspects of an environment 100 or system 102 or other context of structures 210, or a comprehensive summary of all access data storage management mechanisms for potential use in or with a system 102. In particular, the retention periods shown on access data boxes in FIG. 5 are merely examples. Other periods may also be used, and other characteristics than retention period could be used instead or in addition, including any characteristic indicated by a label 310. FIG. 5 items are discussed at various points herein, and additional details regarding them are provided in the discussion of a List of Reference Numerals later in this disclosure document.

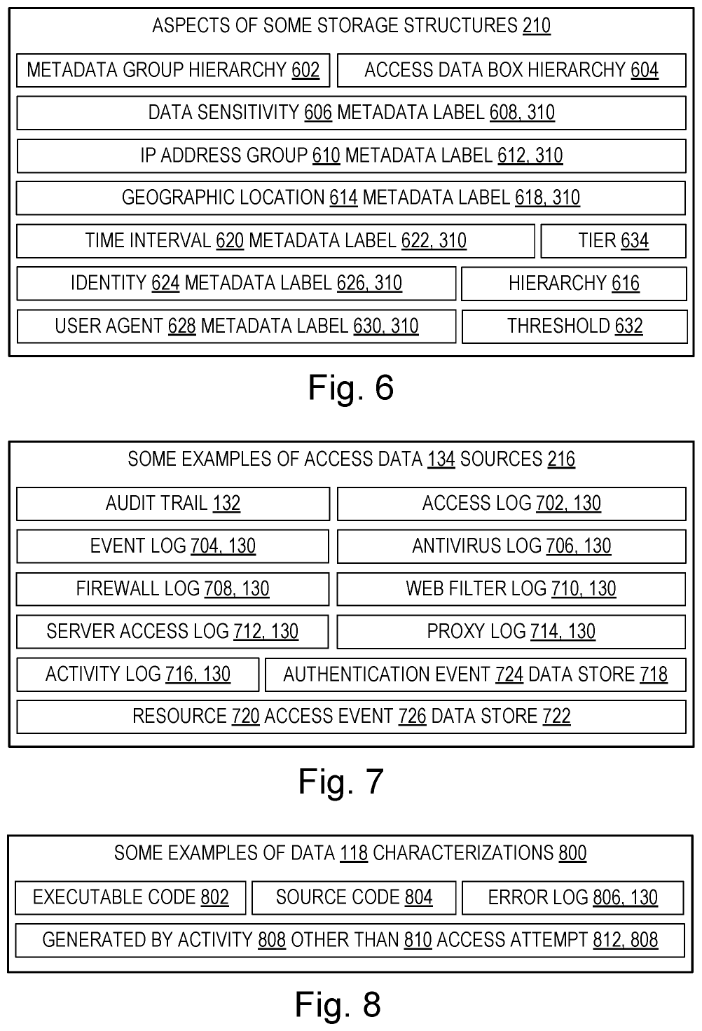

FIG. 6 is a block diagram further illustrating aspects of some access data storage management structures 210. This is not a comprehensive summary of all access data storage management structures 210. FIG. 6 items are discussed at various points herein, and additional details regarding them are provided in the discussion of a List of Reference Numerals later in this disclosure document.

FIG. 7 is a block diagram illustrating examples of some access data sources 216. This is not a comprehensive summary of all access data sources 216 or of all kinds of access data 134. FIG. 7 items are discussed at various points herein, and additional details regarding them are provided in the discussion of a List of Reference Numerals later in this disclosure document.

FIG. 8 is a block diagram illustrating some examples of data 118 characterizations 800. Access data 134 is an example of data 118 generally, and hence is a particular characterization 800. That is, data 118 may be characterized as being access data 134 as opposed to being source code 804 or executable code 802, for example. Characterizations 800 may overlap, e.g., compiler error log 806 data may contain source code data 804. FIG. 8 is not a comprehensive summary of all data characterizations 800 or of all kinds of data 118. FIG. 8 items are discussed at various points herein, and additional details regarding them are provided in the discussion of a List of Reference Numerals later in this disclosure document.

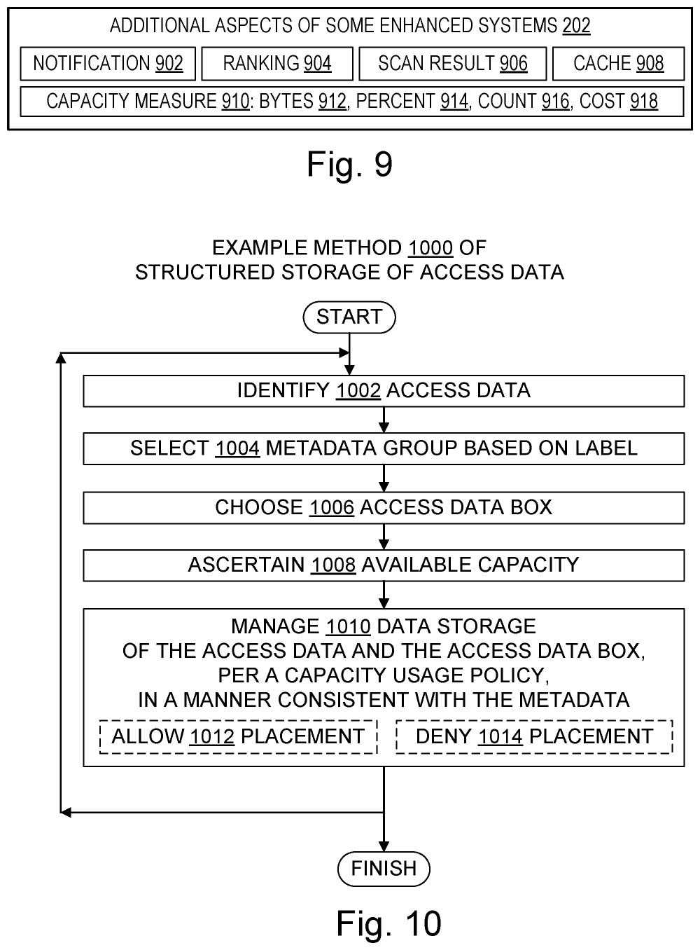

FIG. 9 is a block diagram illustrating some additional aspects of some access data storage management systems 202. This is not a comprehensive summary of all systems 202. FIG. 9 items are discussed at various points herein, and additional details regarding them are provided in the discussion of a List of Reference Numerals later in this disclosure document.

In some embodiments, the enhanced system 202 may be networked through an interface 318. An interface 318 may include hardware such as network interface cards, software such as network stacks, APIs, or sockets, combination items such as network connections, or a combination thereof.

Some embodiments use or include a framework 210 like the one diagrammed in FIG. 4. FIG. 5 shows an example instance of the FIG. 4 framework, where the metadata defines sensitivity groups such as personal information, health information, sensitive sale info, sensitive marketing info, and sensitive product formulas. In FIG. 5, the 1-year access data box holds data that is kept for at least one year after the date of the oldest data in that box, and the 2-year access data box holds data that is kept for at least two years after the date of the oldest data in that box. In a different example, one box could be local storage at a business while the other box is offsite archive storage. The available capacity usage policy 316 helps determine the specific behavior that occurs when one of the access data boxes is full but more access data remains, e.g., whether the leftover access data is stored in a different box, or is not stored at all.

In some embodiments, an enhanced system 202 includes a computing system 202 which is configured to manage storage of access data 134. The enhanced system 202 includes a digital memory 112 and a processor 110 in operable communication with the memory.

In a given embodiment, the digital memory 112 may be volatile or nonvolatile or a mix. A metadata groups structure 308 resides in (and thus configures) the digital memory 112. The metadata groups structure 308 defines at least two metadata groups 304, each metadata group including at least one metadata label 310. An access data boxes structure 312 resides in the digital memory and defines at least two access data boxes 212. Each access data box 212 includes digital storage 112. The access data box 212 itself is not necessarily part of this embodiment, but the access data boxes structure 312 is part of this embodiment. A mapping structure 314 residing in the digital memory represents a mapping 402 between the metadata groups structure 308 and the access data boxes structure 312. The mapping structure 314 also includes an available capacity usage policy 316, either directly or by way of a pointer or other reference mechanism.

In this example, the processor 110 is configured to perform access data storage management steps, i.e., to execute access data storage management. This includes (a) identifying 1002 access data 134 which represents one or more attempts to access stored data 406, the stored data associated with at least one metadata label 310, (b) selecting 1004 a particular metadata group 304 based on at least the metadata label, (c) choosing 1006 a particular access data box 212 based on at least the mapping 402 and the particular metadata group 304, (d) ascertaining 1008 an available capacity 214 of the particular access data box 212, and (e) based on the available capacity 214 and the available capacity usage policy 316, allowing 1012 or denying 1014 placement of at least a portion of the access data 134 in the particular access data box 212.

As a technical benefit, identifying 1002 access data which represents one or more attempts to access stored data, selecting 1004 a particular metadata group based on at least the metadata label, and choosing 1006 a particular access data box based on the mapping 402 and the particular metadata group beneficially provides flexible and granular storage management of access data for different kinds of access data. Storage management distinctions can thus be made, not only as to the sensitivity of accessed data, but also as to the properties of access data boxes.

For example, consistent with FIG. 5, the access data for sales and marketing information can be stored under a different retention rule than the access data for product formulas. This would facilitate, e.g., keeping non-indexed sales and marketing information access data for one year while keeping indexed product formula access data for two years.

As another example, access data that should be kept for three years to satisfy a regulation can be stored in a different box 212 than access data for product development data which is not subject to any regulatory governance. This distinction may reduce storage cost. For instance, it may be the case that the product development access data older than six months has never been needed for a breach investigation. Because the products in this hypothetical obsolesce on a three-month cycle, attackers have never shown any interest in product information that is more than six months old. Storage cost may then be prudently reduced by discarding product development access data after six months. Disposal that is implemented as overwriting storage is made technically and administratively easier by keeping different kinds of data in different boxes instead of intermingling different kinds of access data, e.g., in a single log 130.

More generally, using different access data boxes 212 under the management structures 210 described herein provides flexibility and granularity in several ways. Different access data boxes, and hence different kinds of access data 134, may be stored and kept subject to different respective storage management properties such as retention periods, secure disposal methods, indexing extents, storage locations (e.g., onsite versus offsite, or disk versus tape), permissions and other access controls, and even storage service providers.

In some embodiments, the metadata groups are not in a hierarchy 602, and neither are the access data boxes in a hierarchy 604. However, in some embodiments either or both hierarchies 616 exist and are used in the available capacity usage policy 316. In some embodiments, the system 202 is further characterized in at least one of the following ways: the metadata groups 304 belong to a metadata group hierarchy 616, and the available capacity usage policy 316 allows or denies access data placement based at least in part on the metadata group hierarchy; or the access data boxes 212 belong to an access data box hierarchy 616, and the available capacity usage policy 316 allows or denies access data placement based at least in part on the access data box hierarchy.

For example, an embodiment may have three metadata groups 304 denoted here as A, B, and C in a hierarchy subject to a policy 316 that favors group A access data over group B access data, and favors group B access data over group C access data. Suppose that the embodiment has two access data boxes, one onsite and one offsite. Each box has limited capacity. Under the policy 316 onsite storage of A access data and B access data is favored, and offsite storage of C access data is favored. The policy 316 also specifies that at least three-quarters of the onsite box is reserved for of A access data, and specifies that when A or B access data cannot be placed onsite it is sent instead to the offsite box, unless the offsite box is full, in which case the access data is discarded 1212. In operation, this configuration could lead to any of the following situations as well as many others that are not listed explicitly here but are nonetheless recognizable by one of skill as being consistent with this hypothetical example:
Onsite: 75% A, 25% B, 0% available; Offsite: 20% A, 30% B, 50% available
Onsite: 10% A, 25% B, 65% available; Offsite: 100% B, 0% available
Onsite: 100% A, 0% available; Offsite: 100% A, 0% available
Onsite: 100% A, 0% available; Offsite: 100% B, 0% available
Onsite: 0% A, 25% B, 75% available; Offsite: 100% B, 0% available
Onsite: 0% A, 25% B, 75% available; Offsite: 10% B, 90% C, 0% available

In some embodiments, the metadata labels 310 include at least one of the following: data sensitivity 606 labels 608; IP address group 610 labels 612; geographic location 614 labels 618; time interval 620 labels 622; identity 624 labels 626, or user agent 628 labels 630.

In some embodiments, the access data 134 includes at least one of the following: audit trail 132 data; access log 702 data; event log 704 data; antivirus log 706 data; firewall log 708 data; web filter log 710 data; server access log 712 data; proxy log 714 data; activity log 716 data; authentication event 724 data from a store 718; or resource access event 726 data 134 from a store 722.

In recognition of the emphasis herein on access data 134 as opposed to data 118 generally, other kinds of data may be noted. In some embodiments, less than one percent 632 of the access data satisfies any of the following data characterizations: executable code 802; source code 804; error log 806 data; or data which was generated by activity 808 other than an attempt 812 to access stored data 406. In some embodiments, the threshold 632 is three percent, and in some the threshold 632 is five percent.

These example scenarios are illustrative, not comprehensive. One of skill informed by the teachings herein will recognize that many other scenarios and many other variations are also taught. In particular, different embodiments or configurations may vary as to the number or grouping of metadata labels 310, the number of access data boxes 212, and the policy 316 operations specified for handling low capacity 214 in an access data box 212, for example, and yet still be within the scope of the teachings presented in this disclosure.

Other system embodiments are also described herein, either directly or derivable as system versions of described processes or configured media, duly informed by the extensive discussion herein of computing hardware.

Although specific access data structured storage architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of non-access data or kinds of access data, for example, as well as different technical features, aspects, version controls, security controls, mechanisms, rules, criteria, expressions, hierarchies, operational sequences, data structures, environment or system characteristics, or other access data structured storage functionality 204 teachings noted herein, and may otherwise depart from the particular illustrative examples provided.

Processes (a.k.a. Methods)

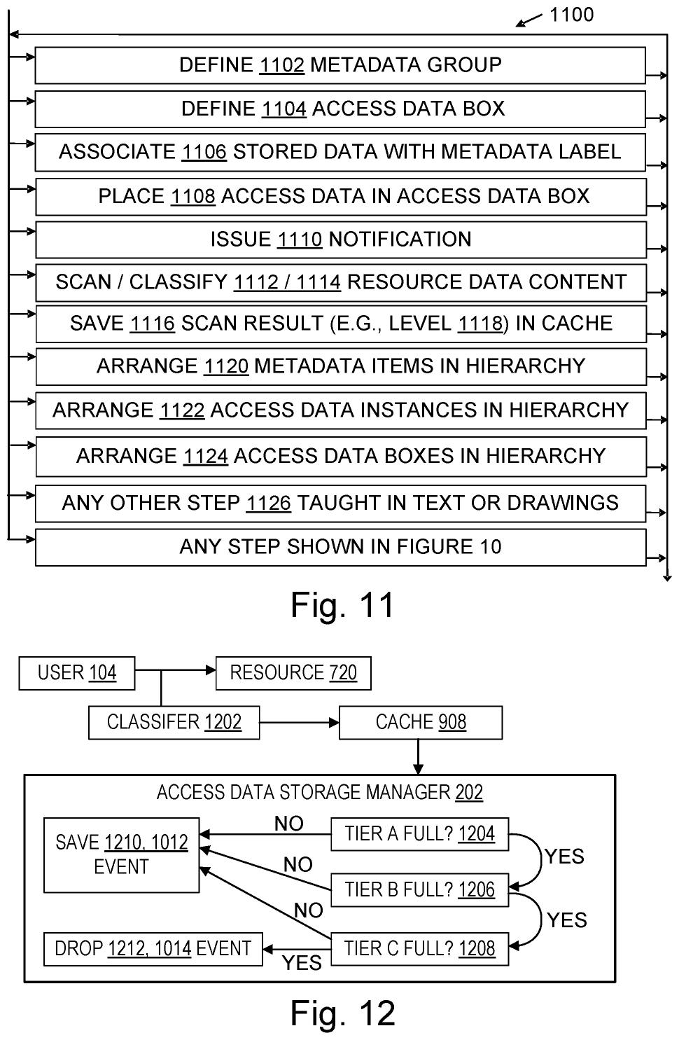

Methods (which may also be referred to as “processes” in the legal sense of that word) are illustrated in various ways herein, both in text and in drawing figures. FIGS. 10 and 11 illustrate families of methods 1000, 1100 that may be performed or assisted by an enhanced system, such as system 202 or another functionality 204 enhanced system as taught herein. FIG. 11 includes some refinements, supplements, or contextual actions for steps shown in FIG. 10, and incorporates the steps of FIG. 10 as options. FIG. 12 illustrates operation of an access data storage manager 202 according to a method 1100.

Technical processes shown in the Figures or otherwise disclosed will be performed automatically, e.g., by an enhanced system 202, unless otherwise indicated. Related processes may also be performed in part automatically and in part manually to the extent action by a human person is implicated, e.g., in some embodiments a human 104 may type in a text name for a metadata label 310, which is then represented digitally in memory 112 within a metadata label data structure 310. But no process contemplated as innovative herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIGS. 10 and 11. Arrows in method or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1000 or 1100 action items are traversed to indicate the steps performed during a process may vary from one performance of the process to another performance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim.

Some embodiments provide or utilize a method for access data storage management, the method performed (executed) by a computing system, the method including: identifying 1002 access data 134 which represents one or more attempts to access stored data 406, the stored data associated with at least one metadata label 310; selecting 1004 a metadata group 304 for the identified access data, the metadata group being selected from among at least two metadata groups, the selecting based on at least the metadata label; choosing 1006 an access data box 212 from among at least two access data boxes, the choosing based on at least the metadata group; ascertaining 1008 an available capacity 214 of the chosen access data box; and based on the available capacity and an available capacity usage policy 316, allowing 1012 or denying 1014 placement in the access data box of at least a portion of access data of the selected metadata group.

Some embodiments conform to a particular configuration in which, e.g., top-level access data goes into a top-level box until the top-level box is full, and then subsequent top-level access data goes into the next box down. This configuration could be useful, e.g., when an estimate of the amount of top-level access data might be low and it is very important to record all top-level access data.

In some embodiments, the metadata groups 304 include a first metadata group and a second metadata group, with the first metadata group ranked 1120, 904 above the second metadata group in a metadata group hierarchy 616; the access data boxes 212 include a first access data box and a second access data box, with the first access data box ranked 1124, 904 above the second access data box in an access data box hierarchy 616; the method operates to allow 1012 placement of access data of the first metadata group in the first access data box until the first access data box has a zero available capacity; and then the method operates to allow 1012 placement of access data of the first metadata group in the second access data box.

Some embodiments conform to a particular configuration in which each kind of access data 134 goes only into its own respective box 212. For example, product research and development (R&D) data goes into an R&D box until that box is full, and then the rest of the R&D access data is discarded, accounts payable data goes into an accounts payable box until that box is full, and then the rest of the accounts payable access data is discarded 1212, and so on. This configuration could be useful, e.g., for incident analysis when available information about the breach suggests what kind of data was breached. Notice that no hierarchies are defined in this particular example.

In some embodiments, the method operates to allow 1012 placement of access data of each metadata group in a respective access data box 212 until the respective access data box has a zero available capacity; and the method operates to deny 1014 placement of access data in any non-respective access data box 212. For example, no R&D access data 134 is stored in the accounts payable box 212.

In some embodiments, the policy 316 specifies available capacity per unit of time. The available capacity could be in gigabytes per hour, for example, and could be reset once per hour. Thus, in some embodiments, the available capacity 214 is ascertained 1008 for only a specified period of time 620.

Some embodiments provide an administrator 104 or an administrative tool 122 with a notification 902 of unused available capacity. An available capacity threshold 632 for notification could be defined as a percentage or as a specific number of gigabytes, etc. For example, notification may occur if 20% of the allocated and paid for capacity remains unused for a month. Thus, in some embodiments the method includes issuing 1110 a notification 902 when an available capacity 214 of an access data box 212 remains above a predefined threshold 632 for a predefined period of time 620.

Some embodiments provide an administrator 104 or an administrative tool 122 with a notification 902 upon reaching a specified low available capacity threshold, or a specified high available capacity threshold, or upon reaching either threshold. For instance, a low-capacity notification may occur 1110 if less than ten gigabytes 632 buffer of available capacity remains in a particular access data box. As another example, a high-capacity notification may occur 1110 if an automatic periodic discarding of data increases combined available capacity of the top three access data boxes to at least one terabyte 632. That is, in some embodiments the method includes issuing 1110 a notification 902 when an available capacity 214 of an access data box 212 reaches a predefined threshold 632.

Some embodiments conform to a particular configuration in which, e.g., top-level access data goes into a top-level box until the top-level box is full, and then the rest of the top-level access data is discarded 1212. This configuration could be useful, e.g., when a regulation or policy requires that at least a certain amount Min of access data for resource R must be retained, and there is no incentive to keep more than Min because other access data is also kept and provides better information for breach incident analysis.

In some embodiments, the metadata groups 304 include a first metadata group and a second metadata group, with the first metadata group ranked 1120 above the second metadata group in a metadata group hierarchy 616; the access data boxes 212 include a first access data box and a second access data box, with the first access data box ranked 1124 above the second access data box in an access data box hierarchy; the method operates to allow 1012 placement of access data of the first metadata group in the first access data box until the first access data box has a zero available capacity; and then the method operates to deny 1014 placement of access data of the first metadata group in any other access data box.

FIG. 12 illustrates an example whose operation proceeds as follows. First a resource 720 (e.g., data 406) is scanned 1112 and classified 1114 according to its content. A classification engine 1202 determines a sensitivity level and saves the data sensitivity indicator 310 in a cache 908. Once access has been made 812 to the resource, a second operational flow will check the sensitivity of the accessed resource against the cache 908 and classify 1106 the access event 726 into a corresponding sensitivity tier 634.

In some embodiments, the method includes: scanning 1112 a resource 720 which includes data content 406; classifying 1114 the resource according to the data content; saving 1116 a resource sensitivity level 1118 in a cache 908 as a particular metadata label 310 associated 1106 with the resource; identifying 1002 access data 134 which represents one or more attempts 812 to access the resource; selecting 1004 a particular metadata group 304 for the identified access data, the selecting based on at least the particular metadata label; choosing 1006 a particular access data box 212 based on at least the particular metadata group; ascertaining 1008 the available capacity 214 of the chosen access data box; and based on the available capacity and the available capacity usage policy, allowing 1012 or denying 1014 placement in the particular access data box of at least a portion of the identified access data of the particular metadata group.

In some embodiments, the available capacity 214 is measured 910 in at least one of the following: a count 916 of bytes 912 of storage; a percentage 914 of a total storage amount; a count 916 of access data events 726; or a financial measure of storage cost 918.

In some embodiments, the available capacity policy 316 is characterized by at least one of the following: access data associated with a given metadata label 310 is only allowed to be stored 1108 in an access data box 212 which is also associated with the given metadata label; metadata labels 310 are arranged 1120 in a metadata label hierarchy 616; instances of access data 134 are arranged 1122 hierarchically; or access data boxes 212 are arranged 1124 hierarchically.

Configured Storage Media

Some embodiments include a configured computer-readable storage medium 112. Storage medium 112 may include disks (magnetic, optical, or otherwise), RAM, EEPROMS or other ROMs, and/or other configurable memory, including in particular computer-readable storage media (which are not mere propagated signals). The storage medium which is configured may be in particular a removable storage medium 114 such as a CD, DVD, or flash memory. A general-purpose memory, which may be removable or not, and may be volatile or not, can be configured into an embodiment using items such as storage structures 210 such as metadata group structures 308 and access data box structures 312, metadata labels 310, capacity usage policies 316, mappings 402, and software 302, in the form of data 118 and instructions 116, read from a removable storage medium 114 and/or another source such as a network connection, to form a configured storage medium. The configured storage medium 112 is capable of causing a computer system 102 to perform technical process steps for structured storage of access data 134, as disclosed herein. The Figures thus help illustrate configured storage media embodiments and process (a.k.a. method) embodiments, as well as system and process embodiments. In particular, any of the process steps illustrated in FIG. 10, 11, or 12, or otherwise taught herein, may be used to help configure a storage medium to form a configured storage medium embodiment.

Some embodiments use or provide a computer-readable storage device 112, 114 configured with data 118 and instructions 116 which upon execution by at least one processor 110 cause a computing system to perform an access data storage management method. This method includes: identifying 1002 access data which represents one or more attempts to access stored data, the stored data associated with at least one metadata label; selecting 1004 a metadata group for the identified access data, the metadata group being selected from among at least two metadata groups, the selecting based on at least the metadata label; choosing 1006 an access data box from among at least two access data boxes, the choosing based on at least the metadata group; ascertaining 1008 an available capacity of the chosen access data box; and based on the available capacity and an available capacity usage policy, managing 1010 placement in the access data box of at least a portion of access data of the selected metadata group.

In some embodiments, the method further includes at least one of the following: issuing 1110 a notification when an available capacity of an access data box remains above a predefined threshold for a predefined period of time; or issuing 1110 a notification when an available capacity of an access data box reaches a predefined threshold.

In some embodiments, the metadata labels include at least one of the following: data sensitivity labels; IP address group labels; or identity labels. In some, the metadata labels include data sensitivity labels. In some, the metadata labels include IP address group labels. In some, the metadata labels include identity labels.

In some embodiments, the metadata groups belong to a metadata group hierarchy, and the available capacity usage policy allows or denies access data placement based at least in part on the metadata group hierarchy.

In some embodiments, the access data boxes belong to an access data box hierarchy, and the available capacity usage policy allows or denies access data placement based at least in part on the access data box hierarchy.

Additional Observations

Additional support for the discussion of access data structured storage functionality 204 herein is provided under various headings. However, it is all intended to be understood as an integrated and integral part of the present disclosure's discussion of the contemplated embodiments.

One of skill will recognize that not every part of this disclosure, or any particular details therein, are necessarily required to satisfy legal criteria such as enablement, written description, or best mode. Any apparent conflict with any other patent disclosure, even from the owner of the present innovations, has no role in interpreting the claims presented in this patent disclosure. With this understanding, which pertains to all parts of the present disclosure, examples and observations are offered herein.

One of skill informed by the teachings herein will recognize the advantages of those teachings over alternative access data storage approaches. For example, some approaches focus on providing the lowest cost storage, even if doing so risks data availability or data integrity. Some approaches focus on reducing the amount of stored access data by omitting certain kinds of access data or retaining access data for a shorter time, even if doing so risks excluding access data that would be very helpful in breach investigation, or risks non-compliance with applicable regulations or corporate policies. Unlike the such broad stroke approaches, embodiments taught herein provide control over access data storage that can be tailored to reduce costs without unidentified violations of policy or unknown non-compliance risks, and without unduly hampering breach investigations.

As an example, consider sensitivity-based access logs 130 filtering. Enterprises may be compelled by prudence, or even required, to store access logs of different resources for extended periods, in order to comply with privacy rules and regulations. Since the volume of this access data can be high, storing it may cost a lot of money, especially if this access data needs to be indexed and readily accessible for querying.

Some environments apply teachings provided herein by classifying the data into sensitivity tiers in a hierarchy 616. Some classify each access attempt 812 according to the data sensitivity tier, and store the corresponding access data 134 only if the tier budget allows it, according to a tier-based budget model. This approach helps ensure that storage costs are capped, and that only the most valuable access data is stored.

In some configurations, sensitivities 606 are prioritized into tiers of a hierarchy 616, with the top tier being the most valuable or sensitive and the lowest tier being the least. A budgeting model is defined, e.g., in a mapping structure 314. For example, one possible budgeting model sets a specific amount of money per sensitivity tier per hour for the storage of access data 134.

In some configurations, two data flows occur: a classification flow and a budgeted storage flow. During the classification flow, the stored data (e.g., data 406 in a resource 720) is scanned 1112 and classified 1114 according to its content. A classification engine 1202 will determine the sensitivity level and save the data sensitivity in a cache 908. Once an access has been made 812 to a resource, the budgeted storage flow will check the sensitivity of the accessed resource against the cache, and classify 1202 the access event 726 into the corresponding sensitivity tier. At this point, the access event 134 along with the sensitivity label 310 will be compared against the budget model 314 and the access data will be stored 1108 only if the budget for the sensitivity tier is not maxed out.

As a specific example, assume a budget model is set as follows, with an event costing $1 to store:
Highly confidential (top tier)— $100 per hour
Confidential (middle tier)— $50 per hour
Public (low tier)— $0 per hour

Then access events will be bucketed into 1 hour window. Assume that in a given hour users accessed 812 resources as follows:
120 Highly confidential resources
40 Confidential resources
20 Public resources

Then in this scenario with this budget model, the 120 high-confidential events will be stored, maxing out the Highly confidential sensitivity tier and leaving $30 in the Confidential tier. Next, of the 40 Confidential events only the top 30 events will be stored before the middle tier budget is maxed out; 10 events will be dropped, as no budget left for the Confidential or the Public tier. The 20 Public resource accesses will also be dropped, as no budget is left for any tier.

FIG. 12 illustrates this example, and other embodiment examples in which a user accesses a resource 720, the resulting access data is classified according to the sensitivity of the accessed resource, and the event classification is stored in a resource sensitivity cache 908. An access data storage manager 202 checks the access data against a highest matched sensitivity tier first. If that tier has budget left, the access event 134 is stored 1108. If not, the access data storage manager 202 checks the access data against the next highest matched sensitivity tier. If that tier has budget left, the access event 134 is stored 1108, and if not, the flow proceeds to the next tier. This example has three tiers, but one of skill will recognize that one or more tiers may be present in a given embodiment. If the last tier checked also has no budget, then the access event 134 is dropped 1212 instead of being stored 1108.

Technical Character

The technical character of embodiments described herein will be apparent to one of ordinary skill in the art, and will also be apparent in several ways to a wide range of attentive readers. Some embodiments address technical activities such as accessing 812 data 118 in a computing system 102, classifying 1114 data 118 as to sensitivity 606, IP address 610 presence, geographic location 614, time interval 620, digital identity 624, or user agent 628, and ascertaining 1008 available storage capacity 214, which are each an activity deeply rooted in computing technology. Some of the technical mechanisms discussed include, e.g., access data storage management data structures 210, access data structured storage software 302, metadata labels 310 and groups 304, and data classifiers 1202. Some of the technical effects discussed include, e.g., reduction in access data storage capacity 214 usage with granular and flexible control over risks such as enterprise policy violation and regulatory non-compliance, and storage 1108 of access data 134 in distinct boxes 212 which have respective metadata and retention characteristics. Thus, purely mental processes and activities limited to pen-and-paper are clearly excluded. Other advantages based on the technical characteristics of the teachings will also be apparent to one of skill from the description provided.

Different embodiments may provide different technical benefits or other advantages in different circumstances, but one of skill informed by the teachings herein will acknowledge that particular technical advantages will likely follow from particular innovation features or feature combinations.

For example, some embodiments specify a storage budget for one or more particular groups 304 of access data 134. One or more access data storage boxes 212 are defined 1104 for the access data groups 304. The access data box 212 definitions implement capacity 214 limitations. When a given box 212 is full (zero available capacity 214), no more access data of the corresponding group is stored in that box 212. This provides a mechanism for storing sufficient access data 134 of each group 304 subject to a cap (maximum), thereby facilitating compliance without unbounded storage costs 918.

Other benefits of particular steps or mechanisms of an embodiment are also noted elsewhere herein in connection with those steps or mechanisms.

Some embodiments described herein may be viewed by some people in a broader context. For instance, concepts such as efficiency, reliability, user satisfaction, or waste may be deemed relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems, such as how to efficiently and effectively control storage of access data 134 in a manner that balances storage cost, regulatory and policy compliance, and breach investigation support. Other configured storage media, systems, and processes involving efficiency, reliability, user satisfaction, or waste are outside the present scope. Accordingly, vagueness, mere abstractness, lack of technical character, and accompanying proof problems are also avoided under a proper understanding of the present disclosure.

Additional Combinations and Variations

Any of these combinations of software code, data structures, logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, peripherals, software process flows, identifiers, data structures, data selections, naming conventions, notations, control flows, or other implementation choices described herein. Any apparent conflict with any other patent disclosure, even from the owner of the present innovations, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
laaS or IAAS: infrastructure-as-a-service
ID: identification or identity
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise the right to specific and chosen lexicography. Quoted terms are being defined explicitly, but a term may also be defined implicitly without using quotation marks. Terms may be defined, either explicitly or implicitly, here in the Detailed Description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

“Access” to a computational resource includes use of a permission or other capability to read, modify, write, execute, move, delete, create, or otherwise utilize the resource. Attempted access may be explicitly distinguished from actual access, but “access” without the “attempted” qualifier includes both attempted access and access actually performed or provided.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” is the computational entity identified by system utilities such as Windows® Task Manager, Linux® ps, or similar utilities in other operating system environments (marks of Microsoft Corporation, Linus Torvalds, respectively). “Process” is also used herein as a patent law term of art, e.g., in describing a process claim as opposed to a system claim or an article of manufacture (configured storage medium) claim. Similarly, “method” is used herein at times as a technical term in the computing science arts (a kind of “routine”) and also as a patent law term of art (a “process”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Access data storage management operations such as identifying 1002 access data, defining 1104 access data storage boxes 212, ascertaining 1008 box available capacity 214, scanning 1112 stored data 406, storing 1108 access data in a storage box 212, and many other operations discussed herein, are understood to be inherently digital. A human mind cannot interface directly with a CPU or other processor, or with RAM or other digital storage, to read and write the necessary data to perform the access data structured storage management steps 1000 taught herein even in a hypothetical prototype situation, much less in an embodiment's real world large computing environment. This would all be well understood by persons of skill in the art in view of the present disclosure.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

“Based on” means based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this innovation disclosure discusses various data values and data structures, and recognize that such items reside in a memory (RAM, disk, etc.), thereby configuring the memory. One of skill will also recognize that this innovation disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational step on behalf of a party of interest, such as allowing, arranging, ascertaining, associating, choosing, classifying, defining, denying, discarding, dropping, identifying, issuing, managing, placing, saving, scanning, selecting, storing (and allows, allowed, arranges, arranged, etc.) with regard to a destination or other subject may involve intervening action, such as the foregoing or such as forwarding, copying, uploading, downloading, encoding, decoding, compressing, decompressing, encrypting, decrypting, authenticating, invoking, and so on by some other party or mechanism, including any action recited in this document, yet still be understood as being performed directly by or on behalf of the party of interest.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein. Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### LIST OF REFERENCE NUMERALS

The following list is provided for convenience and in support of the drawing figures and as part of the text of the specification, which describe innovations by reference to multiple items. Items not listed here may nonetheless be part of a given embodiment. For better legibility of the text, a given reference number is recited near some, but not all, recitations of the referenced item in the text. The same reference number may be used with reference to different examples or different instances of a given item. The list of reference numerals is:
100 operating environment, also referred to as computing environment; includes one or more systems 102
102 computer system, also referred to as a “computational system” or “computing system”, and when in a network may be referred to as a “node”
104 users, e.g., user of an enhanced system 202; refers to a human or a human's online identity unless otherwise stated
106 peripheral device
108 network generally, including, e.g., LANs, WANs, software-defined networks, clouds, and other wired or wireless networks
110 processor; includes hardware
112 computer-readable storage medium, e.g., RAM, hard disks
114 removable configured computer-readable storage medium
116 instructions executable with processor; may be on removable storage media or in other memory (volatile or nonvolatile or both)
118 digital data in a system 102
120 kernel(s), e.g., operating system(s), BIOS, UEFI, device drivers
122 tools, e.g., version control systems, cybersecurity tools, software development tools, office productivity tools, social media tools, diagnostics, browsers, games, email and other communication tools, commands, and so on
124 user interface; hardware and software
126 display screens, also referred to as “displays”
128 computing hardware not otherwise associated with a reference number 106, 108, 110, 112, 114
130 log; digital; an example of access data 134; e.g., record of activity by or at a particular device or within a particular computing system
132 audit trail; digital; an example of access data 134; e.g., record of activity by a particular user or other digital identity; “log” and “audit” are sometimes used interchangeably or in overlap, e.g.. an audit trail may be stored in an audit log
134 access data generally, e.g., digital data representing an access 812 to a device or to a file or other particular data or to another resource 720
136 cloud, cloud computing environment
202 system 102 enhanced with access data structured storage functionality 204
204 functionality for structured storage of access data as taught herein; may also referred to as access data structured storage functionality 204; e.g., software or specialized hardware which performs or is configured to perform steps 1002-1010, software or specialized hardware which utilizes or is configured to utilize a mapping 402 and a capacity usage policy 316, software 302, or any software or hardware which performs or is configured to perform a method 1100 or a computational access data storage management activity first disclosed herein
206 structured access data storage, e.g., access data storage management controlled using storage structures 210, in addition to storage data structures such as file systems, blobs, bad disk sector maps, etc. which are not specific to access data storage as taught herein; FIGS. 4, 5, and 12 illustrate some but not all possible examples
208 storage of access data, e.g., placement or non-placement in volatile or non-volatile memory 112 or both
210 access data storage data structures; also referred to as access data storage structures 210 or storage structures 210 or structures 210 or framework 210; in some embodiments includes a metadata groups structure 308, a mapping structure 314, and an access data boxes structure 312, or functional equivalent; digital; may be implemented, e.g., using data structure components such as objects, structs, pointers, trees, lists, arrays, hashes, and so on; the particular partitioning of functionality shown in FIG. 4 is not required, e.g., the mapping 402 and the capacity usage policy 316 could be distinct data structures instead of residing in a mapping structure 314, in which case they would collectively be a functional equivalent of the mapping structure 314; as another variation example the access data boxes structure 312 could consist solely of the access data box definitions and thus not have any structure apart from their collective structure
212 access data box, e.g., a defined 1104 region of memory 112 (volatile or non-volatile or both), a defined storage appliance, a defined 1104 set of servers 102, a defined data center, or a defined storage service provider
214 access data box capacity; unless stated otherwise, capacity 214 refers to available capacity, namely, storage still available to receive access data, as opposed to referring to used or filled capacity that already holds access data
216 access data source; e.g., computational process or device that emits access data 134 or holds temporarily cached access data 134
302 access data structured storage software, e.g., software which performs steps 1002-1010 upon execution with at least one processor 110
304 metadata group; e.g., a digital representation of one or more resources 720 which have characteristics corresponding to one or more metadata labels 310 that belong to the metadata group 304
306 metadata generally; digital
308 metadata group data structure, e.g., a data structure representing a set of one or more metadata labels 310
310 metadata label; digital; generally includes a human-readable string or name or icon representing a characteristic of one or more resources 720; labels 310 can be used to differentiate between tiers in a hierarchy, but the labels are not exactly the same as a tier, e.g., one tier might be labeled to indicate account numbers inside the United States while another tier is labeled to indicate account numbers in Europe
312 access data box data structure, e.g., a data structure representing an access data box 212
314 mapping data structure, e.g., a digital representation of a correspondence between one or more metadata groups and one or more access data boxes specifying which kind(s) of access data (per metadata group) may be stored in which access data box(es), and also providing a policy 316 specifying whether to store or discard access data when a given access data box has no remaining capacity available to receive that access data for storage
316 available capacity usage policy, e.g., a digital representation of rules, heuristics, or other decision mechanisms specifying whether to store or discard access data when a given access data box has no remaining capacity available to receive that access data for storage
318 interface generally; computational
402 mapping, e.g., digital representation of a correspondence between one or more metadata groups and one or more access data boxes specifying which kind(s) of access data (each kind being defined by a metadata group) may be stored in which access data box(es)
404 access data box definition, e.g., data structure defining the location, extent, lifespan, and other functional scope characteristics of an access data box; e.g., a log file up to one gigabyte in size at location archive/accessdata/box235 or up to 300 gigabytes per month streamed to a cloud account accessdata-logs-monthly, or the H: drive, etc.
406 stored data which is a target of one or more access attempts 812; an example of a resource 720; also referred to as accessed data; although access data 134 may itself also be stored data 406 in some circumstances, in general most stored data 406 is not access data 134; access data 134 and stored data 406 are examples of data 118 generally
602 metadata group hierarchy; an example of a hierarchy 616; an ordering of metadata groups indicating which group(s) are favored over which other group(s) to have their access data stored if storage capacity is available; may be a total ordering in which any two groups are ordered relative to one another (e.g., A<B<C<D) or a partial ordering in which at least two groups have no order relative to one another but do each have an order relative to other group(s) (e.g., A<{B, C}<D); the hierarchy is represented digitally
604 access data box hierarchy; an example of a hierarchy 616; an ordering of access data boxes indicating which box(es) are favored over which other box(es) to receive access data for storage if storage capacity is available; may be a total ordering in which any two boxes are ordered relative to one another (e.g., A<B<C<D) or a partial ordering in which at least two boxes have no order relative to one another but do each have an order relative to other box(es) (e.g., A<{B, C}<D); the hierarchy is represented digitally
606 data sensitivity, as represented digitally (i.e., in a computing system 102), e.g., a confidentiality or privacy level or category
608 data sensitivity metadata label; might indicate, e.g., top-secret/confidential/public, or could indicate, e.g., “health info”/“account number”/“date of birth”, etc.; an example of a metadata label 310
610 group of one or more IP addresses; may be IPv4 or IPv6
612 IP address group metadata label; might indicate a specific set or range of one or more IP addresses; might also or instead indicate IP address characteristics, e.g., internal/external, or a country of origin, or whether or not the IP address is hosted, etc.; an example of a metadata label 310
614 geographic location, as represented digitally
616 hierarchy generally, as represented digitally
618 geographic location metadata label; might indicate, e.g., a location in the real world such as a building number, postal address, city, state, province, region, country, continent, or jurisdiction (e.g., inside/outside GDPR area); an example of a metadata label 310
620 time or time interval, as represented digitally
622 time or time interval metadata label; might indicate an absolute time (e.g., January 2022) or a relative time (e.g., most recent six months); an example of a metadata label 310
624 digital identity, e.g., as represented in an identity directory of a computing system 102
626 identity metadata label; might indicate, e.g., an account user, or a role in a role-based authentication system; an example of a metadata label 310
628 user agent, as represented digitally in network communications
630 user agent metadata label; an example of a metadata label 310
632 threshold generally, as represented digitally
634 tier, e.g., the box(es) 212 associated with a given metadata group 304, or may refer to the metadata group 304 itself, depending on the context.
702 access log; digital; example of access data 134
704 log of events 724 or 726 or both; digital; example of access data 134
706 antivirus tool 122 log; digital; example of access data 134
708 firewall 122 log; digital; example of access data 134
710 web filter 122 log; digital; example of access data 134
712 server 102 access log; digital; example of access data 134
714 proxy 122 log; digital; example of access data 134
716 activity 808 log; digital; example of access data 134
718 authentication event 724 data store, e.g., database, log, repository, blob, file; digital; example of access data 134
720 resource in a computing system 102, e.g., data 118, memory 112, processor 110, kernel 120, tool 122, network 108, display 126, hardware 128, bandwidth, endpoint, directory, repository, credential, token, etc.
722 resource access event 726 data store, e.g., database, log, repository, blob, file; digital; example of access data 134
724 authentication event, e.g., digital representation of a creation, transmission, submission, receipt, verification, modification, cancellation, or acceptance of an authentication credential; although authorization and authentication may be distinguished in some circumstances, for present purposes they may be treated as each being associated with one or more events 724
726 access event, e.g., digital representation of an attempt to access a resource; a given embodiment may or may not distinguish between successful and failed access attempts, but for present purposes each is associated with one or more events 726; see also definition of “access”
800 data 118 characterization; may be implicit, e.g., in how data 118 is processed
802 executable code; see definitions of “executable” and “code”
804 source code, e.g., in a scripting programming language or a programming language that can be compiled or interpreted by an interpreter 122
806 log of warning messages, error message, or both, emitted by a tool 122
808 activity generally as represented in a computing system 102
810 activity other than access attempt activity 812, as represented in a computing system 102
812 access attempt activity 812, as represented in a computing system 102, e.g., by event data structures or digital values
902 notification computational activity, digital content, or digital result, in a computing system 102
904 ranking computational activity, digital content, or digital result, within a hierarchy 616
906 scanning result, in a system 102
908 cache or other memory 112 designated for a particular kind or category of data
910 storage capacity metric or measurement computational activity or digital result in a computing system
912 bytes
914 percentage or fraction, e.g., 30% and 0.30 are each and example of an item 914
916 count of an item, as represented digitally; may be zero or non-zero (a given embodiment may ascribe meaning to a negative count)
918 cost, e.g., in dollars, euros, or another recognized currency
1000 flowchart; 1000 also refers to structured storage of access data methods that are illustrated by or consistent with the FIG. 10 flowchart
1002 computationally identify access data, e.g., by its location in a system 102, by its time frame, by its source, or by its other associated metadata label value(s)
1004 computationally select a metadata group based on associated metadata label value(s)
1006 computationally choose one or more access data boxes, e.g., based on a policy 316 and mapping 402 and the metadata label value(s) associated with access data and the access data boxes
1008 computationally ascertain an available capacity, e.g., based on file system or kernel calls in combination with caps specified by a policy 316 and a box definition 404
1010 computationally manage storage of access date, e.g., by one or more of: allowing 1012 certain storage activity, denying 1014 certain storage activity, issuing 1110 notification(s), or reclaiming available storage to increase capacity
1012 computationally allow certain storage activity, e.g., by asking a file system or kernel or storage utility to perform the storage activity or by performing the storage activity
1014 computationally deny certain storage activity, e.g., by avoiding asking a file system or kernel or storage utility to perform the storage activity or by avoiding performing the storage activity
1100 flowchart; 1100 also refers to structured storage of access data methods illustrated by or consistent with the FIG. 11 flowchart (which incorporates the steps of FIG. 10)
1102 computationally define a metadata group, e.g., by populating a metadata group data structure 304
1104 computationally define an access data box, e.g., by populating an access data box definition data structure 404
1106 computationally associate stored data 406 a one or more metadata labels, e.g., by populating a data structure with value(s) from a classifier 1202
1108 computationally place access data in an access data box, e.g., by calls to a file system or kernel or storage utility 122; such placing may also be referred to as storing, and placement may be referred to as storage
11110 computationally issue a notification, e.g., via text message, email, synthesized voice message, or visual and audible alert in a user interface
1112 computationally scan resource data content, e.g., by calls to a file system or kernel or storage utility 122; may include parsing to identify particular kinds of data, e.g., account numbers; may read previously stored metadata
1114 computationally classify resource data content, e.g., using a rules engine, machine learning model, heuristics, or other classifier 1202; classification associates metadata label(s) with scanned data 406
1116 computationally save a scan result 906, e.g., a classification, in a memory 112
1118 scan result, e.g., a classification level or category, as represented digitally, e.g., as one or more metadata labels 310 or as an indication that no scanning was permitted or that scanning found no items corresponding to any metadata label
1120 computationally arrange metadata items (labels 310, groups 304, or both) in a hierarchy 616, e.g., by populating a hierarchy data structure as specified by an admin or by security personnel
1122 computationally arrange access data instances (e.g., different files or directories of data 406) in a hierarchy 616, e.g., by populating a hierarchy data structure as specified by an admin or by security personnel
1124 computationally arrange access data boxes 212 in a hierarchy 616, e.g., by populating a hierarchy data structure as specified by an admin or by security personnel
1126 any step discussed in the present disclosure that has not been assigned some other reference numeral
1202 data classifier mechanism, e.g., rules engine or machine learning model; computational
1204 tier A structures and related items and computational steps in FIG. 12 example
1206 tier B structures and related items and computational steps in FIG. 12 example
1208 tier C structures and related items and computational steps in FIG. 12 example
1210 computationally save access data; an example of placement 1108 and of allowing 1012
1212 computationally drop access data; an example of denying 1014

### CONCLUSION

In short, the teachings herein provide a variety of access data structured storage functionalities 204 which operate in enhanced systems 202. Some embodiments manage 1010 storage 1108 of access data 134 using a set of data structures 210 which provide flexible and granular control over storage costs 918 without undue risk to enterprise policy compliance, regulatory compliance, or data breach investigation capability. Accessible data 406 and other resources 720 are classified 1114 and labeled 1106 by metadata labels 310 according to their characteristics. When resources 720 are accessed 812, the resulting access data 134 is associated 1002, 1004 with the metadata labels 310 of the accessed resource 720. Metadata labels 310 can be grouped 1102. A mapping structure 314 defines a mapping 402 between one or more metadata groups 304 (and hence the corresponding access data 134) on the one hand and one or more access data storage boxes 212, on the other hand. Access data storage box definitions 404 may specify metadata labels 310. The mapping structure 314 also defines a policy 316 for the use of available storage capacity 214 in the access data storage boxes 212. Per the policy 316 and the available capacity 214, particular access data 134 may be stored 1108 in a particular box 212, or be spilled over 1108, 1204, 1206 to a different particular box 212, or be denied 1014, 1212 storage in any of the data boxes 212. Accordingly, the costs 918 of storing access data 134 can be capped and made predictable, and the storage 1108 of specific kinds of access data 134 can be favored.

Embodiments are understood to also themselves include or benefit from tested and appropriate security controls and privacy controls such as the General Data Protection Regulation (GDPR). Use of the tools and techniques taught herein is compatible with use of such controls.

Although Microsoft technology is used in some motivating examples, the teachings herein are not limited to use in technology supplied or administered by Microsoft. Under a suitable license, for example, the present teachings could be embodied in software or services provided by other cloud service providers.

Although particular embodiments are expressly illustrated and described herein as processes, as configured storage media, or as systems, it will be appreciated that discussion of one type of embodiment also generally extends to other embodiment types. For instance, the descriptions of processes in connection with FIGS. 10-12 also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific code, such as specific thresholds, comparisons, specific kinds of platforms or programming languages or architectures, specific scripts or other tasks, and specific computing environments, and thus need not appear in every embodiment. Those of skill will also understand that program identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law.” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; innovators are not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computing system which is configured to manage storage of access data, the computing system comprising:
a digital memory;
a metadata groups structure residing in the digital memory and defining at least two metadata groups, each metadata group including at least one metadata label;
an access data boxes structure residing in the digital memory and defining at least two access data boxes, each access data box including digital storage;
a mapping structure residing in the digital memory, the mapping structure representing a mapping between the metadata groups structure and the access data boxes structure, the mapping structure including an available capacity usage policy;
a processor in operable communication with the digital memory, the processor configured to execute access data storage management including: (a) identifying access data which represents one or more attempts to access stored data, the stored data associated with at least one metadata label, (b) selecting a particular metadata group based on at least the metadata label, (c) choosing a particular access data box based on at least the mapping and the particular metadata group, (d) ascertaining an available capacity of the particular access data box, and (e) based on the available capacity and the available capacity usage policy, allowing or denying placement of at least a portion of the access data in the particular access data box.

2. The computing system of claim 1, further characterized in at least one of the following ways:
the metadata groups belong to a metadata group hierarchy, and the available capacity usage policy allows or denies access data placement based at least in part on the metadata group hierarchy; or
the access data boxes belong to an access data box hierarchy, and the available capacity usage policy allows or denies access data placement based at least in part on the access data box hierarchy.

3. The computing system of claim 1, wherein the metadata labels include at least one of the following:
data sensitivity labels;
IP address group labels;
geographic location labels;
time interval labels;
identity labels; or
user agent labels.

4. The computing system of claim 1, wherein the access data includes at least one of the following:
audit trail data;
access log data;
event log data;
antivirus log data;
firewall log data;
web filter log data;
server access log data;
proxy log data;
activity log data;
authentication event data; or
resource access event data.

5. The computing system of claim 1, wherein less than one percent of the access data satisfies any of the following data characterizations:
executable code;
source code;
error log data; or
data which was generated by activity other than an attempt to access stored data.

6. An access data storage management method, the method executed by a computing system, the method comprising:
identifying access data which represents one or more attempts to access stored data, the stored data associated with at least one metadata label;
selecting a metadata group for the identified access data, the metadata group being selected from among at least two metadata groups, the selecting based on at least the metadata label;
choosing an access data box from among at least two access data boxes, the choosing based on at least the metadata group;
ascertaining an available capacity of the chosen access data box; and
based on the available capacity and an available capacity usage policy, allowing or denying placement in the access data box of at least a portion of access data of the selected metadata group.

7. The method of claim 6, wherein:
the metadata groups include a first metadata group and a second metadata group, the first metadata group ranked above the second metadata group in a metadata group hierarchy;
the access data boxes include a first access data box and a second access data box, the first access data box ranked above the second access data box in an access data box hierarchy;
the method operates to allow placement of access data of the first metadata group in the first access data box until the first access data box has a zero available capacity; and then
the method operates to allow placement of access data of the first metadata group in the second access data box.

8. The method of claim 6, wherein:
the method operates to allow placement of access data of each metadata group in a respective access data box until the respective access data box has a zero available capacity; and
the method operates to deny placement of access data in any non-respective access data box.

9. The method of claim 6, wherein the available capacity is ascertained for only a specified period of time.

10. The method of claim 6, further comprising issuing a notification when an available capacity of an access data box remains above a predefined threshold for a predefined period of time.

11. The method of claim 6, further comprising issuing a notification when an available capacity of an access data box reaches a predefined threshold.

12. The method of claim 6, wherein:
the metadata groups include a first metadata group and a second metadata group, the first metadata group ranked above the second metadata group in a metadata group hierarchy;
the access data boxes include a first access data box and a second access data box, the first access data box ranked above the second access data box in an access data box hierarchy;
the method operates to allow placement of access data of the first metadata group in the first access data box until the first access data box has a zero available capacity; and then
the method operates to deny placement of access data of the first metadata group in any other access data box.

13. The method of claim 6, wherein the method comprises:
scanning a resource which includes data content;
classifying the resource according to the data content;
saving a resource sensitivity level in a cache as a particular metadata label associated with the resource;
identifying access data which represents one or more attempts to access the resource;
selecting a particular metadata group for the identified access data, the selecting based on at least the particular metadata label;
choosing a particular access data box based on at least the particular metadata group;
ascertaining the available capacity of the chosen access data box; and
based on the available capacity and the available capacity usage policy, allowing or denying placement in the particular access data box of at least a portion of the identified access data of the particular metadata group.

14. The method of claim 6, wherein the available capacity is measured in at least one of the following:
a count of bytes of storage;
a percentage;
a count of access data events; or
a financial measure of storage cost.

15. The method of claim 6, wherein the available capacity policy is characterized by at least one of the following:
access data associated with a given metadata label is only allowed to be stored in an access data box which is also associated with the given metadata label;
metadata labels are arranged in a metadata label hierarchy;
instances of access data are arranged hierarchically; or
access data boxes are arranged hierarchically.

16. A computer-readable storage device configured with data and instructions which upon execution by a processor cause a computing system to perform an access data storage management method, the method comprising:
identifying access data which represents one or more attempts to access stored data, the stored data associated with at least one metadata label;
selecting a metadata group for the identified access data, the metadata group being selected from among at least two metadata groups, the selecting based on at least the metadata label;
choosing an access data box from among at least two access data boxes, the choosing based on at least the metadata group;
ascertaining an available capacity of the chosen access data box; and
based on the available capacity and an available capacity usage policy, managing placement in the access data box of at least a portion of access data of the selected metadata group.

17. The computer-readable storage device of claim 16, wherein the method further comprises at least one of the following:
issuing a notification when an available capacity of an access data box remains above a predefined threshold for a predefined period of time; or
issuing a notification when an available capacity of an access data box reaches a predefined threshold.

18. The computer-readable storage device of claim 16, wherein the metadata labels include at least one of the following:
data sensitivity labels;
IP address group labels; or
identity labels.

19. The computer-readable storage device of claim 16, wherein the metadata groups belong to a metadata group hierarchy, and the available capacity usage policy allows or denies access data placement based at least in part on the metadata group hierarchy.

20. The computer-readable storage device of claim 16, wherein the access data boxes belong to an access data box hierarchy, and the available capacity usage policy allows or denies access data placement based at least in part on the access data box hierarchy.
